(19) United States
(12) Patent Application Publication
(10) Pub. No.: US 2010/0043605 A1
(43) Pub. Date: Feb. 25, 2010

(54) "Optimized Key Ring Separator"

(76) Inventor: Mark Konkel, New Berlin, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/502,841

(22) Filed: Jul. 14, 2009

Related U.S. Application Data
(60) Provisional application No. 61/090,119, filed on Aug. 19, 2008.

(51) Int. Cl. B25B 27/00; B23P 15/00

(52) U.S. Cl. 81/485; 29/407.05

(57) ABSTRACT

An optimized key ring separator used for splitting and holding open a key ring so that a key can be inserted or removed. The optimized key ring separator consists of a flange attached to an enclosed or unenclosed mounting portion, and may include optional gripping edges. The flange is comprised of a flange base and edges which are tapered resulting in a peak which allows it to be wedged between the turns of a key ring separating the turns of the ring. The flange may also include flattened edges. The key ring separator may also include an attachment member, which allows selective positioning of the flange and removal of any key on a key ring.

### CROSS-REFERENCE TO RELATED APPLICATIONS

This application claims priority to U.S. Provisional Application No. 61/090,119 filed on Aug. 19, 2008.

### FIELD OF THE INVENTION

The present invention pertains to key ring systems and more particularly to a device for spreading apart the adjacent segments of a commercially available “split” key ring.

### BRIEF DESCRIPTION OF THE DRAWINGS

FIG. 1 illustrates a side perspective view of an exemplary embodiment of an optimized key ring separator with a closed mounting portion and a flange that has tapered edges.

FIG. 2a illustrates a side perspective view of an exemplary embodiment of an optimized key ring separator with a closed mounting portion and a flange that has flattened edges and tapered edges.

FIG. 2b illustrates a three-dimensional view of an exemplary embodiment of an optimized key ring separator with a closed mounting portion and a flange that has flattened edges and tapered edges.

FIG. 3a illustrates a side perspective view of an exemplary embodiment of an optimized key ring separator with an open mounting portion, a flange that has tapered edges and a looped attachment component which allows keys to be removed selectively.

FIG. 3b illustrates a side perspective view of an exemplary embodiment of an optimized key ring separator with an open mounting portion, a flange that has flattened edges and tapered edges, and a looped attachment component which allows keys to be removed selectively.

FIG. 3c illustrates a side perspective view of an exemplary embodiment of an optimized key ring separator with an open mounting portion, a flange that has tapered edges, and a clasped attachment component.

FIG. 4 illustrates a side perspective view of an exemplary embodiment of an optimized key ring separator with a closed mounting portion, a flange that has flattened edges and tapered edges, and a gripping edge.

FIG. 5 illustrates a side perspective view of an exemplary embodiment of an optimized key ring separator with a closed mounting portion and a flange that has flattened edges and tapered edges.

FIG. 6 illustrates a side perspective view of a split key ring separated by an exemplary embodiment of an optimized key ring separator with a closed mounting portion and a flange that has flattened edges and tapered edges.

### BACKGROUND

Perhaps the most common and dependable device for carrying keys is a split key ring. This device provides almost two turns of spring steel (“split key ring components”) of rigid metal that are wound so that a pair of end segments are spring-pressed against a center segment, with the end segments terminating in ends where keys enter and leave the ring. Although keys are very securely retained by such a key ring, this very security makes moving keys on and off very difficult since the tightly wound turns of the ring must be spread apart far enough to allow passage of a key.

Typically, a user may attempt to use the head of a key itself by wedging it between one of the ends and the center segment of a split key ring. Failing with this, or alternatively, one may attempt to spread the key ring apart by inserting a finger nail between the end and the center segment, possibly breaking the finger nail or hurting the finger. If there are many keys on the ring, or if other items such as a pocket knife are carried on the ring, the bulk of keys and other items may add resistance to spreading the segments of the key ring. This problem of adding and removing keys is realized by anyone who carries keys, but it is especially annoying to those who regularly use keys in their daily work, such as those who work in the maintenance and security trades.

Others have recognized the problem of opening a key ring as described above. As might be expected, the prior efforts have involved some type of device or implement for wedging and spreading the segments of the key ring apart.

Several devices which exist in the prior art are made of plastic which lacks strength or contain bulky components and designs which are difficult to manipulate with one hand.

It is desirable to have a key ring separator which easily opens split key rings with a single hand and which is designed to open a split key ring using minimal force or leverage.

It is further desirable to have a key ring separator which is compact and does not add bulk to a key ring. Key ring separators in the prior art add bulk to a ring already full of keys and are not as simple to use as might be desired.

Finally, it is desirable to have a key ring separator which can be used to add or remove any key on a ring without taking other keys off the ring.

Glossary

As used herein, the term “key ring separator” refers to a device for separating the components of a split key ring.

As used herein, the term “flange” refers to a structural protrusion capable of being inserted between two adjacent objects (e.g., the components of a split key ring). A flange can be triangular, rectangular or any other shape. A flange has a horizontal measurement and a vertical measurement.

As used herein, the term “flange base” refers to the portion of the flange which is adjacent to the mounting portion of the key ring separator. A flange base has a horizontal measurement and a vertical measurement.

As used herein, the term “tapered edge” refers to an edge that gradually decreases in width or thickness.

As used herein, the term “flattened edge” refers to a visible surface on which a split key ring component may rest.

As used herein, the term “stationary” refers to a component in a fixed position or one that is not moving.

As used herein, the term “advertising indicia” refers to a message, picture, logo, design, or other identifying images or print.

As used herein, the term “attachment component” refers to a component or device which attaches a key ring separator to a split key ring, and which includes but is not limited to the mounting portion itself, a string, a wire, a clip, a tether, a clasp or other attachment device known in the art.

As used herein, the term “mounting portion” refers to the structural component of a key ring separator onto which a flange is attached, molded, welded or tooled. The mounting portion may be round, square, triangular, unshaped or any other shape adapted for mounting.

As used herein, the term “closed” refers to a component which does not have endpoints.

As used herein, the term “open” refers to a component which has endpoints.

As used herein, the term “gripping edge” refers to an edge of a mounting portion of a key ring separator which is adapted for gripping or holding. For example a gripping edge may be a serrated edge, a non-slip edge, a textured edge, a flattened edge or other type of surface to facilitate gripping with the fingertips.

As used herein, the term “eyelet” refers to a component for affixing an attachment member to a key ring separator.

As used herein, the term “horizontal measurement” refers to the width of a flange or flange base measured at any two points alone a horizontal plane.

As used herein, the term “vertical measurement” refers to a measurement of a flange or flange base taken vertically at any point along the flange (e.g., the height (distance) from the apex of a flange to the flange base).

As used herein, the term “protruding object” refers to a hook, post or other object from which a ring (e.g., including but not limited to a key ring) may be suspended.

As used herein, the term “flexible split key ring component” refers to a component of a split key ring that is adapted in any manner to be more easily moved or separated than a rigid key ring structure, but which returns to a closed position for retaining and securing keys after a key is added or removed.

As used herein, the term “fabricating” refers to machining, molding, extruding, cutting, shaping, welding or any other means of forming a component.

### DETAILED DESCRIPTION OF EMBODIMENTS OF THE INVENTION

For the purpose of promoting an understanding of the present invention, references are made in the text hereof to embodiments of an optimized key ring separator, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar locations, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a representative basis for teaching one of ordinary skill in the art to employ the present invention in virtually any appropriately detailed apparatus or manner.

It should be understood that the drawings are not necessarily to scale; instead, emphasis is being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

### SUMMARY OF THE INVENTION

An optimized key ring separator for spreading apart the adjacent end and intermediate portions of a split key ring that are spring-urged against each other along the inner surfaces of the split key ring components but are spreadable to allow a key to be placed on or taken off the ring is disclosed herein. The optimized key ring separator is adapted to encircle a key ring in the same way as a key and will remain on the key ring along with the keys and will not come off of the key ring while it is being used to insert or remove a key from the key ring. The optimized key ring separator includes a flange attached to an enclosed or unenclosed mounting portion. The gripping edge of the optimized key ring separator makes it easy to grip the key ring separator and wedge the flange between adjacent segments of the key ring spreading the segments apart.

This purpose of this invention is to facilitate the spreading apart of the segments of a key ring so that keys can be added to or removed from the key ring. The key ring separator is easily attached and removed from a key ring, and may include attachment components such as a string, a wire, a clip, a tether, a clasp or other attachment device.

The dimensions of the flange are experimentally designed to spread apart the segments of a key ring while the key ring separator remains on the key ring. The flange is mounted on a mounting component which may have special gripping edges. Some embodiments of a key ring separator may have flattened edges which allow for easy gripping. A serrated and/or flattened gripping edge may facilitate use of the key ring separator.

The key ring separator spreads apart the segments of a key ring and then provides a gap through which a key can pass, as the key ring separator, followed by the key, are slid around the key ring either to be placed on the ring or to be removed from the ring.

The key ring separator is thus able to leverage the segments of a key ring apart by rolling the separator between the fingers of one hand using an optimally designed flange made of a material providing optimum leverage.

The key ring separator disclosed herein is compact and lightweight and can be carried on a key ring with keys and other items thereon while occupying a minimum amount of space on the ring and in a user's pocket, purse or other area used for storing keys. It is also easy and inexpensive to manufacture through extrusion and/or other mass production processes.

### DETAILED DESCRIPTION OF THE DRAWINGS

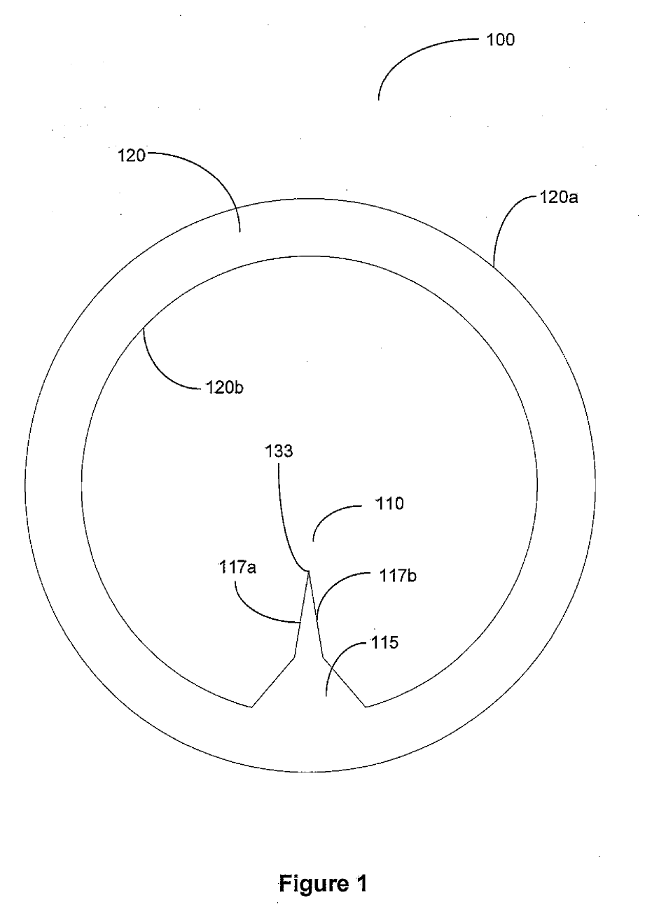

Referring now to the drawings, FIG. 1 shows a side perspective view of an exemplary embodiment of optimized key ring separator 100 with closed mounting portion 120 and flange 110 which is attached to closed mounting portion 120. Closed mounting portion 120 has outer surface 120a and inner surface 120b. In the embodiment shown, mounting portion 120, outer surface 120a and inner surface 120b are of a circular shape. In other embodiments, mounting portion 120, outer surface 120a and/or inner surface 120b may be oval, square, triangular, rectangular, a bar or a solid configuration.

Flange 110 further includes flange base 115 which is attached to inner surface 120b of mounting portion 120 and tapered edges 117a, 117b which terminate in flange point 133. In the embodiment shown, flange base 115 has a horizontal measurement of one to eight millimeters and tapered edges 117a, 117b have a vertical measurement of one to eight millimeters. Flange 110 has a vertical measurement of 0.05 to 2.0 millimeters. In other embodiments, flange 110 may have one or more flattened edges.

In the embodiment shown, optimized key ring separator 100 is made of aluminum, but can be made of any other alloy or metal of sufficient strength and machining capability. In the exemplary embodiment shown, optimized key ring separator 100 is made of 6061 aluminum and is made using extrusion. In other embodiments, optimized key ring separator 100 may be made by molding or machining. In some embodiments, the color of key ring separator 100 is changed through powder-coating or another method known in the art.

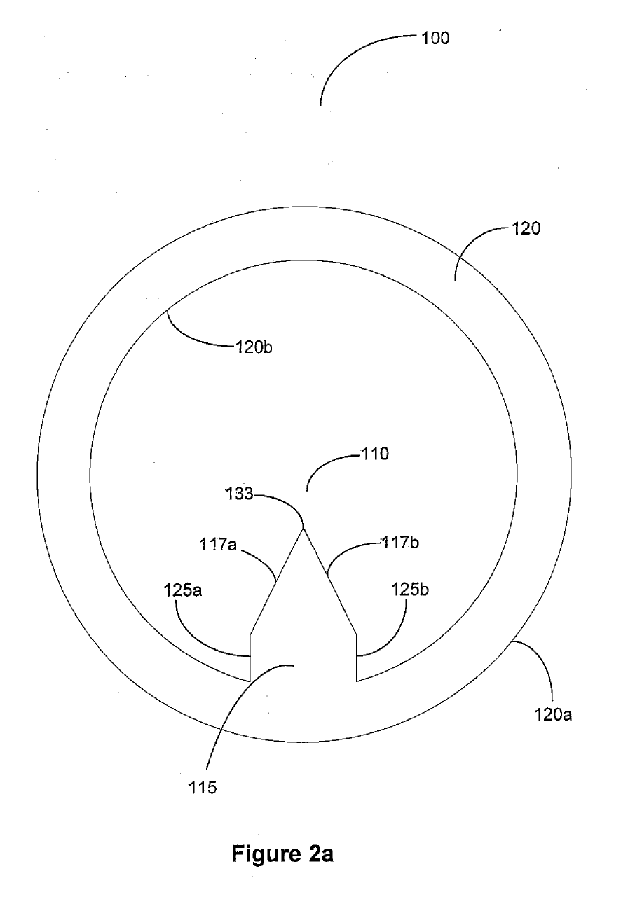

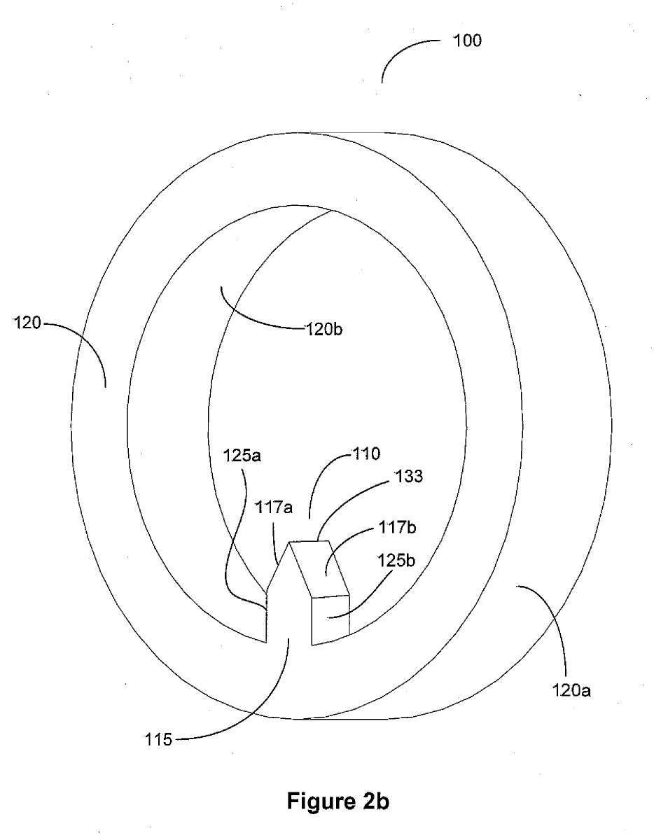

FIG. 2a shows a side perspective view of an exemplary embodiment of optimized key ring separator 100 with closed mounting portion 120 and flange 110 which is attached to closed mounting portion 120. Closed mounting portion 120 has outer surface 120a and inner surface 120b. In the embodiment shown, mounting portion 120, outer surface 120a and inner surface 120b are of a circular shape. In other embodiments, mounting portion 120, outer surface 120a and/or inner surface 120b may be oval, square, triangular, rectangular, a bar or a solid configuration.

Flange 110 further includes flange base 115 which is attached to inner surface 120b of mounting portion 120 and tapered edges 117a, 117b which terminate in flange point 133. In the embodiment shown, flange base 115 has flattened edges 125a, 125b. The segments of a split key ring rest securely against flattened edges 125a, 125b when flange 110 is wedged between the segments of a split key ring.

FIG. 2b shows a three-dimensional view of an exemplary embodiment of optimized key ring separator 100 with closed mounting portion 120 and flange 110. Flange 110 furthers include flange base 115 which has flattened edges 125a, 125b, and tapered edges 117a, 117b which terminate in flange point 133.

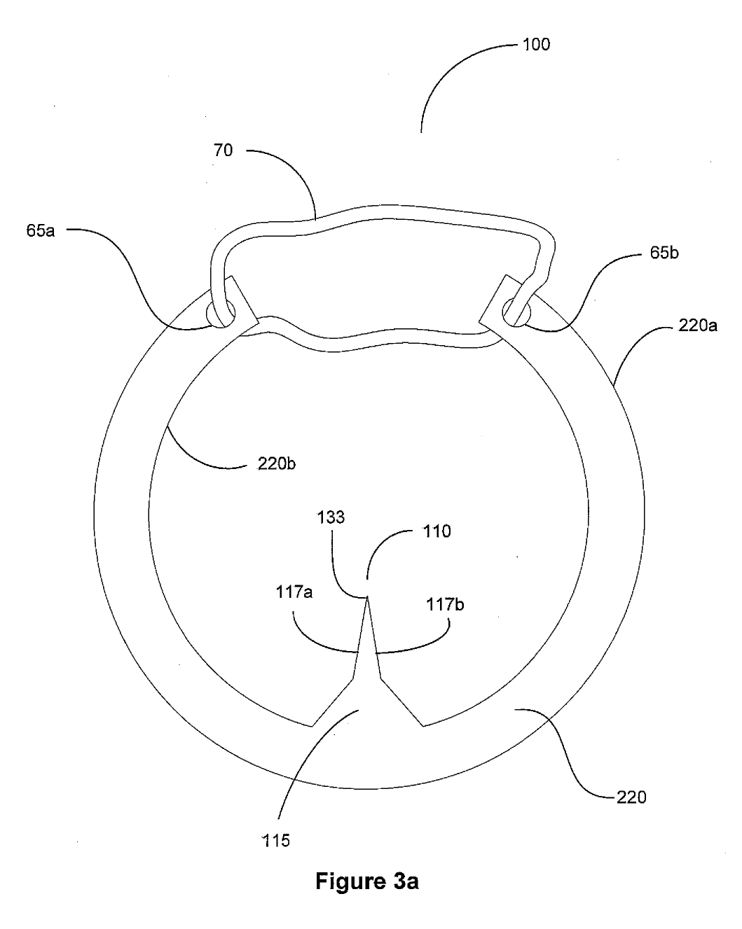

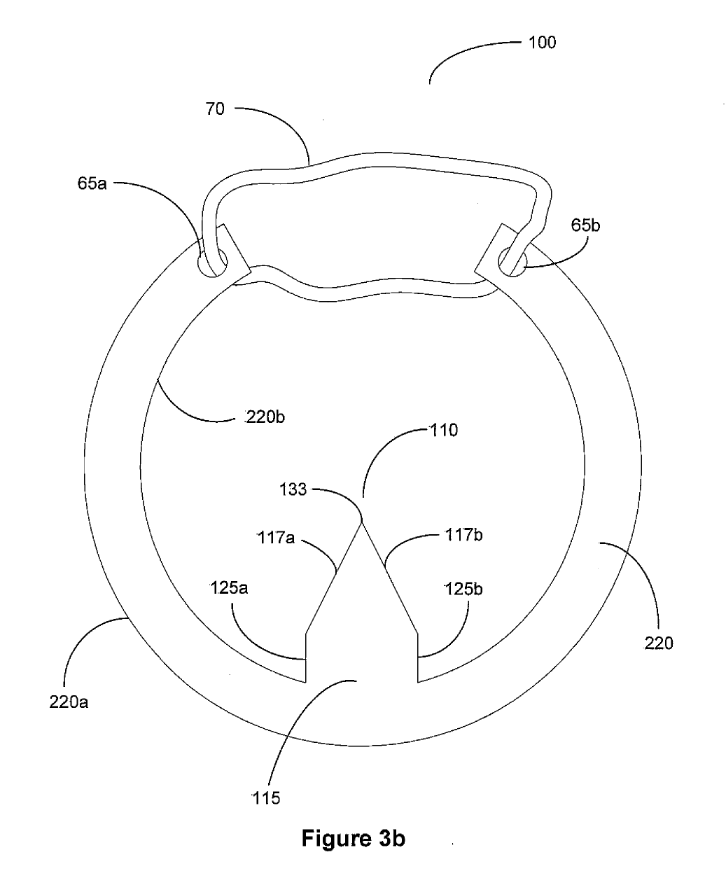

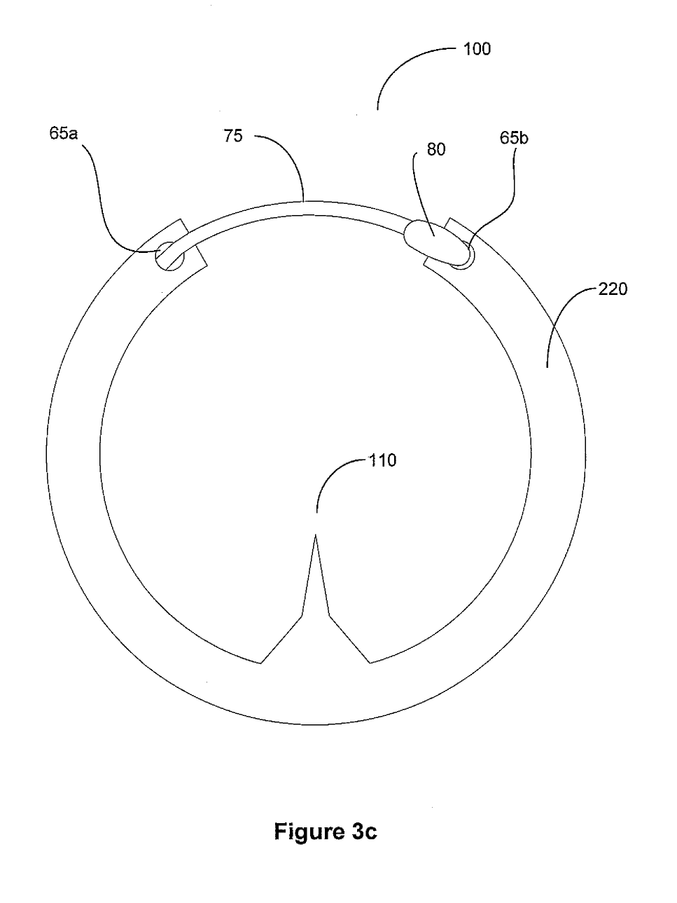

FIG. 3a shows a side perspective view of an exemplary embodiment of optimized key ring separator 100 with open mounting portion 220 and flange 110. Flange 110 further includes flange base 115 which is attached to inner surface 220b of mounting portion 220 and tapered edges 117a, 117b which terminate in flange point 133.

Optimized key ring separator 100 further includes eyelets 65a, 65b and attachment component 70 which is threaded through eyelets 65a, 65b and secured together at the ends. Attachment component 70 allows the key ring separator to be moved to the part of the split key ring adjacent to the key that is to be removed without having to remove optimized key ring separator 100 from the split key ring and place it back on the split key ring adjacent to the key to be removed. In the embodiment shown, attachment component 70 is a flexible string. In other embodiments, attachment component 70 is a wire, a clip, a tether, a cord, a clasp, a hook, a non-looped string, a chain or any other attachment device known in the art which can be affixed to one or more eyelets.

FIG. 3b shows a side perspective view of an exemplary embodiment of optimized key ring separator 100 with open mounting portion 220 and flange 110. Flange 110 further includes flange base 115 which is attached to inner surface 220b of mounting portion 220 and tapered edges 117a, 117b which terminate in flange point 133. In the embodiment shown, flange base 115 has flattened edges 125a, 125b. The segments of a split key ring rest securely against flattened edges 125a, 125b when flange 110 is wedged between the segments of a split key ring.

Optimized key ring separator 100 further includes eyelets 65a, 65b and attachment component 70 which is threaded through eyelets 65a, 65b and secured together at the ends. Attachment component 70 allows the key ring separator to be moved to the part of the split key ring adjacent to the key that is to be removed without having to remove optimized key ring separator 100 from the split key ring and place it back on the split key ring it adjacent to the key to be removed. In the embodiment shown, attachment component 70 is a flexible string. In other embodiments, attachment component 70 is a wire, a clip, a tether, a cord, a clasp, a hook, a non-looped string, a chain or any other attachment device known in the art which can be affixed to one or more eyelets.

FIG. 3c shows a side perspective view of optimized key ring separator 100 with open mounting portion 220 and flange 110. Optimized key ring separator 100 further includes eyelets 65a, 65b and attachment component 75 which is threaded through eyelets 65a and secured with clasp 80 to eyelet 65b. In the embodiment shown, attachment component 75 is a wire with clasp 80 at one end. In other embodiments, attachment component 75 has a closure mechanism other than a clasp. Attachment component 75 allows the key ring separator to be moved to the part of the split key ring adjacent to the key that is to be removed without having to remove optimized key ring separator 100 from the split key ring and place it back on the split key ring it adjacent to the key to be removed.

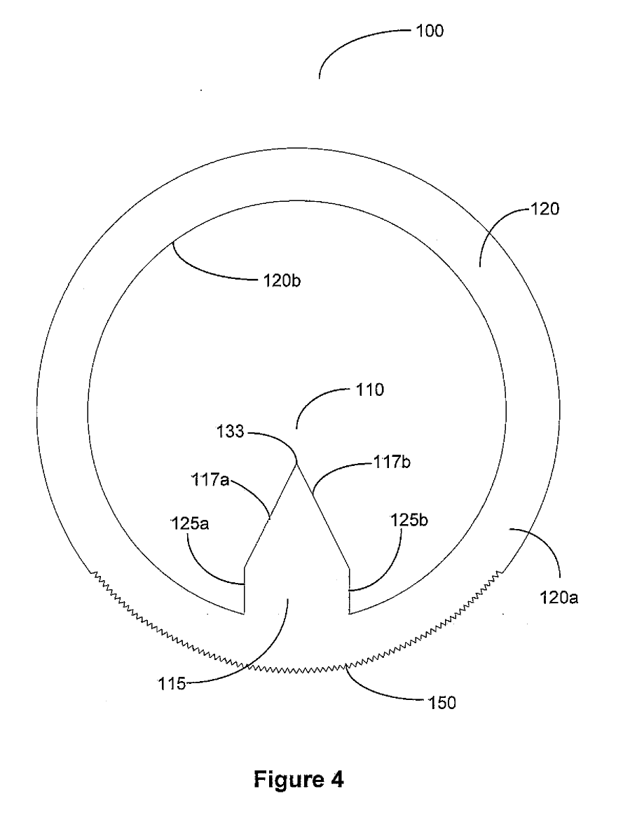

FIG. 4 shows a side perspective view of an exemplary embodiment of optimized of optimized key ring separator 100 with closed mounting portion 120 and flange 110 which is attached to closed mounting portion 120. Closed mounting portion 120 has outer surface 120a and inner surface 120b. In the embodiment shown, mounting portion 120, outer surface 120a and inner surface 120b are of a circular shape. In other embodiments, mounting portion 120, outer surface 120a and/or inner surface 120b may be oval, square, triangular, rectangular, a bar or a solid configuration.

Flange 110 further includes flange base 115 which is attached to inner surface 120b of mounting portion 120 and tapered edges 117a, 117b which terminate in flange point 133. In the embodiment shown, flange base 115 has flattened edges 125a, 125b. The segments of a split key ring rest securely against flattened edges 125a, 125b when flange 110 is wedged between the segments of a split key ring. Also visible is gripping edge 150.

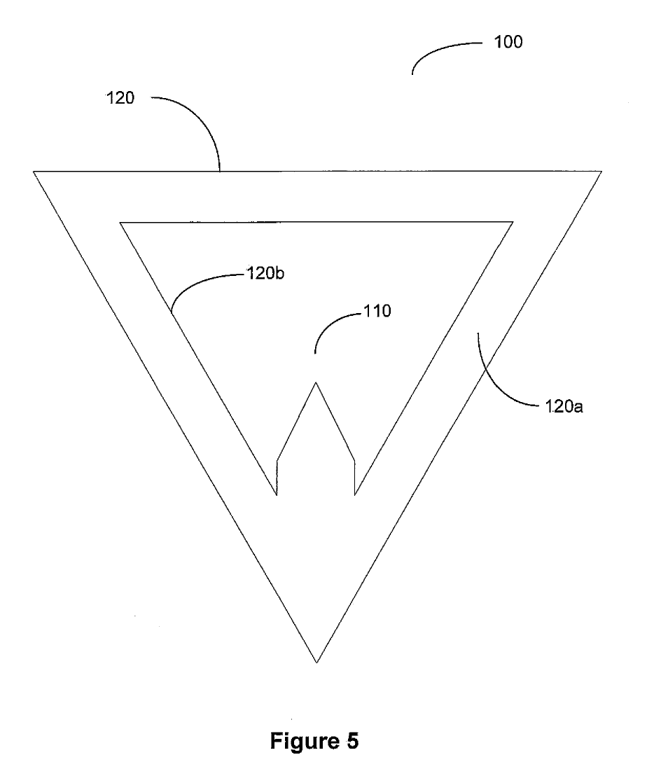

FIG. 5 shows a side perspective view of an exemplary embodiment of optimized key ring separator 100 with closed mounting portion 120 and flange 110. In the embodiment shown, inner surface 120b and outer surface 120a of mounting portion are triangular in shape. In other embodiments, inner surface 120b and outer surface 120a of mounting portion 120 may be of a shape other than a triangle, such as a circle, square, u-shape, bar, oval or other solid configuration.

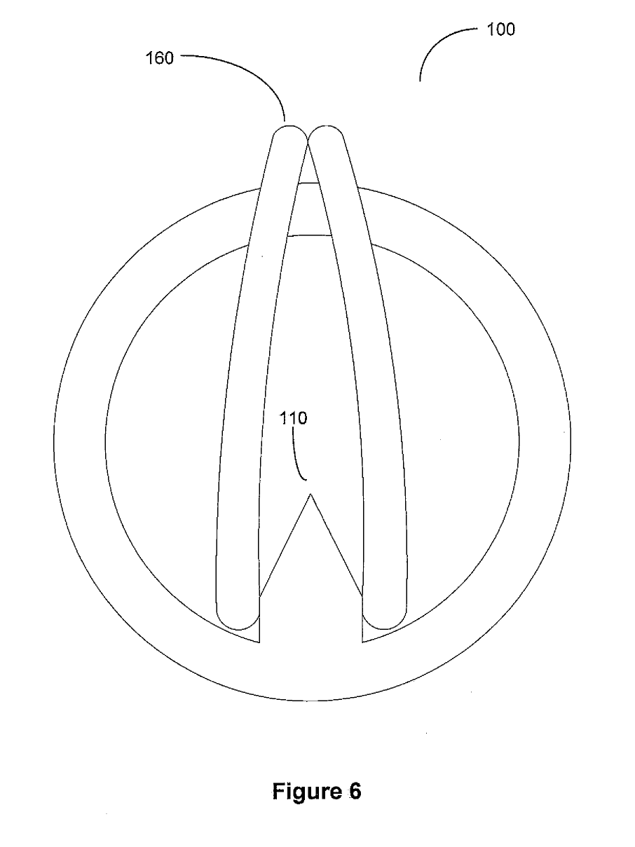

FIG. 6 shows a side perspective view of split key ring 160 separated by a closed optimized split key ring 100 having flange 110.

What is claimed is:

1. A key ring separator apparatus comprised of:
a mounting portion;
an integrally constructed flange fixedly attached to said mounting portion, said flange having a flange base and first flange side and a first tapered edge, said first tapered edge being integrally molded with said first flange side, said flange further including a second flange side and a second tapered edge, said second tapered edge being integrally molded with said second flange side; and
a flange point which is formed from said first tapered edge and said second tapered edge.

2. The apparatus of claim 1 wherein said first flange side and said second flange side are substantially flattened.

3. The apparatus of claim 2 wherein said first flange side and said second flange side are substantially flattened to allow the internal surfaces of a split key ring component to rest in a stationary position on said first flange side and said second flange side.

4. The apparatus of claim 1 wherein the horizontal measurement of said flange base is between one and eight millimeters.

5. The apparatus of claim 1 wherein the horizontal measurement of said flange base is approximately four millimeters.

6. The apparatus of claim 1 wherein said integrally constructed flange has a vertical measurement from said flange base to said flange point, said vertical measurement being between 0.05 millimeters to 2.0 millimeters.

7. The apparatus of claim 1 wherein said mounting portion is adapted to be suspended from a protruding object to support a split key ring.

8. The apparatus of claim 1 which is treated with a powder coating having a color that is different from the material from which said apparatus is constructed.

9. The apparatus of claim 1 wherein said powder coating is friction resistant.

10. The apparatus of claim 1 which is further adapted to receive advertising indicia on one or more surfaces of said apparatus.

11. The apparatus of claim 1 which includes at least one eyelet.

12. The apparatus of claim 1 wherein said mounting portion is a closed structure.

13. The apparatus of claim 1 wherein said mounting portion is an open structure.

14. The apparatus of claim 1 wherein said mounting portion is of a shape selected from a group consisting of oval, triangular, round, square, rectangular, u-shaped, c-shaped, v-shaped, I-shaped and irregular shape.

15. A method of making a key ring separator apparatus consisting of the steps of:
fabricating a mounting portion; and
forming a flange component have a first flange side, a second flange side, a first tapered edge, and a second tapered edge, said first tapered edged and said second tapered edge joining to form a flange point.

16. The method of claim 15 wherein said mounting portion is of a shape selected from a group consisting of oval, triangular, round, square, rectangular, u-shaped, c-shaped, v-shaped, I-shaped and irregular shape.

17. The method of claim 15, wherein said first flange side and said second flange side are substantially flattened.

18. The method of claim 15 wherein the horizontal measurement of said flange base is between one and eight millimeters.

19. The method of claim 15 wherein said flange has a vertical measurement from said base to said flange point, said vertical measurement being between 0.05 millimeters to 2.0 millimeters.

20. A key ring separator system to facilitate the retention, addition and removal of keys using a split key ring comprised of:
a first component comprised of a split key ring having flexible key ring components; and
a second component comprised of a mounting portion having an integrally constructed flange having a flange base, a first flattened side, a first tapered edge integrally molded with said first flattened side, a second flattened side and a second tapered edge integrally molded with said second flattened side, said first tapered edge and said second tapered edge forming a flange point.
